(19) United States
(12) Patent Application Publication
(10) Pub. No.: US 2026/0054771 A1
(43) Pub. Date: Feb. 26, 2026

(54) INDUCTIVE AND MAGNETIC MULTITURN ABSOLUTE STEERING ANGLE SENSOR

(71) Applicant: Steering Solutions IP Holding Corporation, Saginaw, MI (US)

(72) Inventors: Jared K. Moore, Saginaw, MI (US); Keith A. Kidder, Saginaw, MI (US)

(21) Appl. No.: 18/815,215

(22) Filed: Aug. 26, 2024

(51) Int. Cl. B62D 6/00; G01D 5/244; G01D 5/245

(52) U.S. Cl. CPC B62D 6/002; G01D 5/24485; G01D 5/2455; G01D 2205/24; G01D 2205/26

(57) ABSTRACT

A system for controlling a steering system of a vehicle includes sensors configured to sense a plurality of values corresponding to operation of the steering system, and a controller configured to receive the sensed plurality of values, the sensed plurality of values including inductive angle signals and a magnetic angle signal, based on the inductive angle signals, obtain a relative angle of a steering shaft using a first Vernier algorithm, based on the relative angle obtained by the first Vernier algorithm and the magnetic angle signal, obtain an absolute angle of the steering shaft using a second Vernier algorithm, and control the steering system based on the absolute angle obtained using the second Vernier algorithm.

### TECHNICAL FIELD

This disclosure relates to steering systems of vehicles, and more particularly to absolute steering angle sensing techniques for steering systems.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY OF THE INVENTION

This disclosure relates generally to absolute steering angle sensing techniques for steering systems.

An aspect of the disclosed embodiments includes a system for controlling a steering system of a vehicle that includes sensors configured to sense a plurality of values corresponding to operation of the steering system and a controller configured to receive the sensed plurality of values, the sensed plurality of values including inductive angle signals and a magnetic angle signal, based on the inductive angle signals, obtain a relative angle of a steering shaft using a first Vernier algorithm, based on the relative angle obtained by the first Vernier algorithm and the magnetic angle signal, obtain an absolute angle of the steering shaft using a second Vernier algorithm, and control the steering system based on the absolute angle obtained using the second Vernier algorithm.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2 generally illustrates an example inductive torque and angle sensor according to the principles of the present disclosure.

FIG. 3 an example system and process for obtaining an absolute steering angle according to the present disclosure.

FIG. 4 is a flow diagram generally illustrating steps of an example method for obtaining an absolute steering angle according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

In steering systems, an absolute steering angle indicates an exact position of a steering wheel or handwheel relative to a straight-ahead position. The absolute steering angle is used in various calculations and vehicle control systems, such as steering control systems, autonomous and semi-autonomous or cooperative driving, etc. Typically, a steering system includes an absolute steering angle sensor to sense the absolute steering angle.

Systems and methods according to the present disclosure are configured to provide absolute steering angle sensing using inductive torque sensing techniques. An example inductive torque sensor includes an input shaft rotor, an output shaft rotor, and a printed circuit board (PCB) containing sensing circuitry as described below in more detail. The inductive torque sensor measures the angular position of the input shaft rotor and the output shaft rotor and the derivation of the angular position of the input shaft rotor and the output shaft rotor is performed using an inductive measurement method. A transmitting coil on the PCB is energized with an alternating electromagnetic field using specialized ICs configured for inductive sensing. The electromagnetic field produced by the transmitting coil induces eddy currents in the input and output shaft rotor metallic structures. These induced eddy currents produce their own induced electromagnetic fields which interact with the fields produced by the transmitting coil via superposition, creating regions of non-uniform electromagnetic field amplitude below the rotors.

Receiving coils arranged on the PCB detect the electromagnetic fields in the region below the rotors, producing a variable output that varies as a function of the rotational position of the rotors. Inductive sensing circuitry receives electrical signals from the receiving coils and obtains (e.g., calculates) equivalent angular positions based on the signals. These angular positions are mathematically subtracted to produce a differential angle signal. This differential angle signal can then be scaled in a manner that it is directly proportional to the applied input torque.

As an example, the input shaft rotor and output shaft rotor are coupled to respective shafts (i.e., an input shaft and an output shaft, respectively) with a torsion bar extending between the input shaft and the output shaft. As torque is applied to the input shaft and causes the input shaft to rotate, the output shaft may not rotate the same amount as the input shaft due to angular twisting of the torsion bar (i.e., torque applied to the input shaft may not be translated directly to the output shaft as the torsion bar twists in response to the torque). However, the torsion bar has a linear relationship between the applied torque and the angular twisting (i.e., a differential angle) between the input and output shafts. As such, in accordance with the principles of the present disclosure, the differential angle can be measured and used, in a simple linear conversion, to calculate units of torque applied to the input shaft.

In an example, an inductive torque sensor includes two rotors having a non-integer ratio of measurement periodicity to one another. In other words, over one rotation of the steering shaft (or, in some examples, over a unit fraction of a rotation), the inductive angle measurement derived from one rotor will repeat a different number of times than the other rotor, with no direct integer ratio between this number of periods between the rotors. Accordingly, in one example using this type of inductive sensor, an absolute multi-turn steering angle is determined using one of the two inductive angle signals in combination with a separate magnetic angle signal derived from a rotating gear wheel that is geared to the steering shaft with a given gear ratio. The combination of the angles from the inductive angle signal and the magnetic angle signal must be unique over multiple turns of the steering shaft in order to derive a unique absolute steering angle using these angular references.

In this example, mechanizing the sensor with inductive periodicity and the magnetic gear wheel ratio to both optimize the torque measurement accuracy and also provide for a robust absolute angle detection algorithm is difficult. Further, torque sensor accuracy increases as the number of inductive periods increases. However, the greater the difference in angle periodicity between the inductive angle and the magnetic angle used in the absolute angle detection algorithm, the less tolerant to measurement errors the detection algorithm becomes. Accordingly, there is a tradeoff between torque measurement accuracy and the robustness or error tolerance of the absolute angle algorithm.

Absolute steering angle sensing systems and methods using inductive torque sensing according to the present disclosure take advantage of both inductive angle signals used in the torque sensor measurement to derive an altogether different angular reference signal that provides the relative position of the steering shaft over 360 degrees of shaft rotation (or, in some examples, over a unit fraction of a rotation). Since the two inductive angle measurements have a unique rotational relationship over one rotation of the shaft (or over a unit fraction of a rotation), with a different number of periods completed by either angle over one shaft rotation (or over the unit fraction of a rotation), a Vernier algorithm can be employed to derive the position of the shaft. Once the shaft position has been derived using the Vernier algorithm, the magnetic gear wheel angle can be used in conjunction with this shaft angle signal in a second Vernier algorithm to produce a multi-turn steering angle of the shaft. The full measurement range may be dependent upon the gear ratio used to drive the magnetic gear wheel.

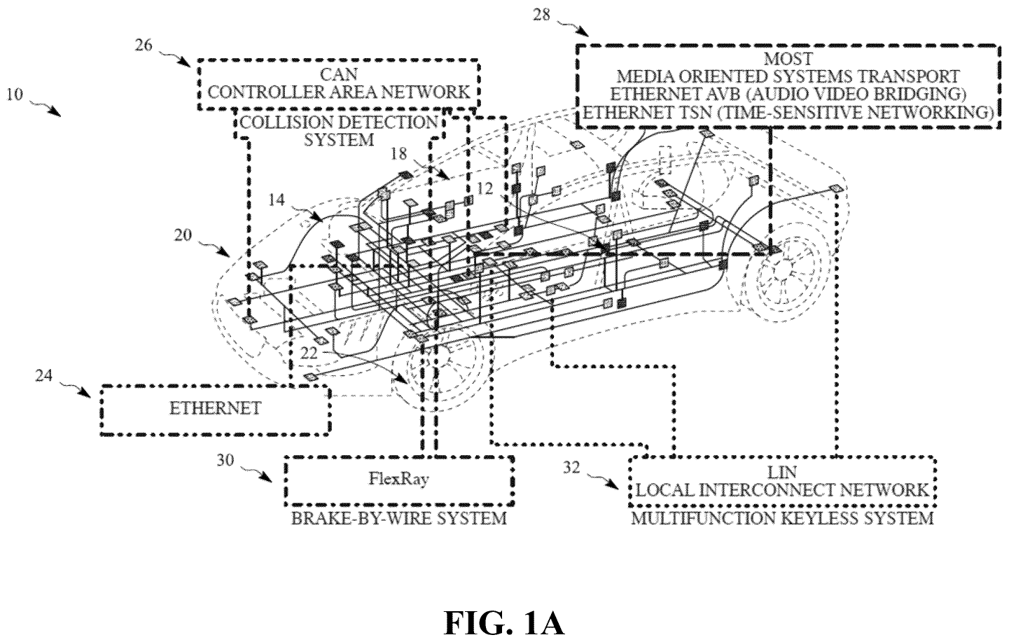

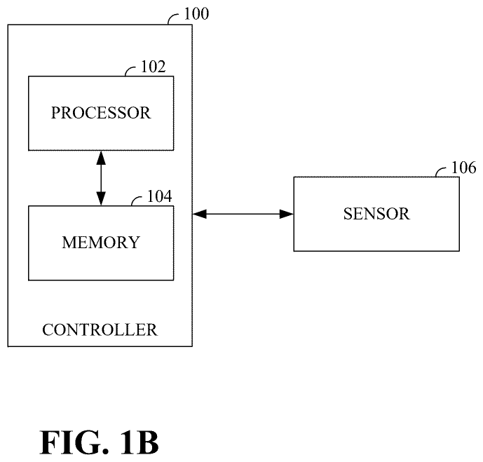

FIG. 1A generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

In some embodiments, the vehicle 10 may include a controller, such as controller 100, as is generally illustrated in FIG. 1B. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof.

In some embodiments, the controller 100 may be configured to implement absolute steering angle sensing techniques according to the principles of the present disclosure. However, the methods described herein as performed by the controller 100 are not meant to be limiting, and any type of software executed on a controller or processor can perform the methods described herein without departing from the scope of this disclosure. For example, a controller, such as a processor executing software within a computing device, can perform the methods described herein.

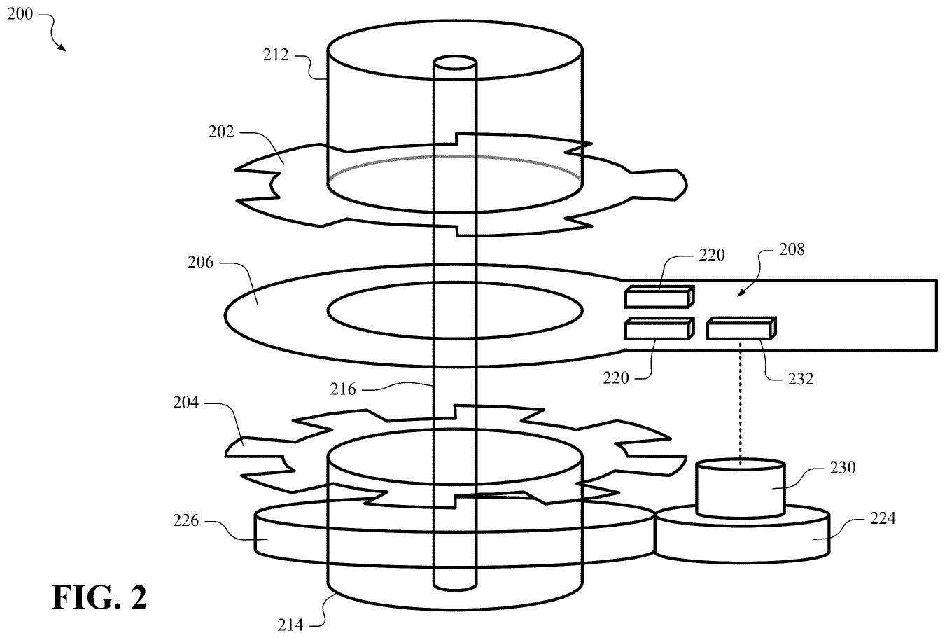

FIG. 2 shows an example inductive torque sensor 200 according to the present disclosure. The inductive torque sensor 200 includes an input shaft rotor 202, an output shaft rotor 204, and a printed circuit board (PCB) 206 containing sensing circuitry 208 as described below in more detail. For example, the input shaft rotor 202 is coupled to an input shaft 212 and the output shaft rotor 204 is couple to an output shaft 214, and the input shaft 212 and the output shaft 214 are coupled together via a torsion bar 216. Accordingly, rotation of the input shaft 212 transfers rotational force and motion to the output shaft 214.

The inductive torque sensor 200 measures an angular position of the input shaft rotor 202 and the output shaft rotor 204 and the derivation of the angular position of the input shaft rotor 202 and the output shaft rotor 204 is performed using an inductive measurement method. In an example, a transmitting coil on the PCB 206 is energized with an alternating electromagnetic field using specialized ICs configured for inductive sensing. The electromagnetic field produced by the transmitting coil induces eddy currents in the metallic structures of the input and output shaft rotors 202, 204. The induced eddy currents produce respective induced electromagnetic fields, which interact with fields produced by the transmitting coil via superposition, creating regions of non-uniform electromagnetic field amplitude below the rotors 202, 204. Receiving coils arranged on the PCB 206 detect the electromagnetic fields in the regions below the rotors 202, 204, producing a variable output that varies as a function of the rotational position of the rotors 202, 204. Inductive sensing circuitry (e.g., one or more inductive sensors 220) receives electrical signals from the receiving coils and obtains equivalent angular positions based on the signals. These angular positions are mathematically subtracted to produce a differential angle signal. This differential angle signal can then be scaled in a manner that it is directly proportional to the applied input torque.

In an example, the rotors 202, 204 have a non-integer ratio of measurement periodicity to one another. In other words, over one rotation (or one unit fraction of a rotation) of a steering shaft corresponding to the input shaft 212, the inductive angle measurement derived from one rotor will repeat a different number of times than the other rotor, with no direct integer ratio between this number of periods between the rotors 202, 204. Accordingly, in one example using this type of inductive sensor, an absolute multi-turn steering angle is determined using one of the two inductive angle signals in combination with a separate magnetic angle signal derived from a rotating gear wheel 224 that is geared to the steering shaft with a given gear ratio (e.g., via a driving gear 226). The rotating gear wheel 224 includes a magnet 230, and rotation of the magnet 230 is sensed by one or more magnetic angle sensors 232 to obtain a magnetic angle signal (e.g., a magnetic gear angle or signal). The combination of the angles from the inductive angle signal and the magnetic angle signal must be unique over multiple turns of the steering shaft in order to derive a unique absolute steering angle using these angular references.

In this example, mechanizing the sensor with inductive periodicity and the magnetic gear wheel ratio to both optimize the torque measurement accuracy and also provide for a robust absolute angle detection algorithm is difficult. Further, torque sensor accuracy increases as the number of inductive periods increases. However, the greater the difference in angle periodicity between the inductive angle and the magnetic angle used in the absolute angle detection algorithm, the less tolerant to measurement errors the detection algorithm becomes. Accordingly, there is a tradeoff between torque measurement accuracy and the robustness or error tolerance of the absolute angle algorithm.

Absolute steering angle sensing systems and methods using inductive torque sensing according to the present disclosure take advantage of both inductive angle signals used in the torque sensor measurement to derive an altogether different angular reference signal that provides the relative position of the steering shaft over 360 degrees of shaft rotation (or, in some examples, over a unit fraction of a rotation). Since the two inductive angle measurements have a unique rotational relationship over one rotation (or over a unit fraction of a rotation) of the steering shaft, with a different number of periods completed by either angle over one shaft rotation, a Vernier algorithm can be employed to derive the position of the steering shaft. Once the shaft position has been derived using the Vernier algorithm, the magnetic gear wheel angle can be used in conjunction with this shaft angle signal in a second Vernier algorithm to produce a multi-turn steering angle of the steering shaft. The full measurement range may be dependent upon the gear ratio used to drive the magnetic gear wheel 224.

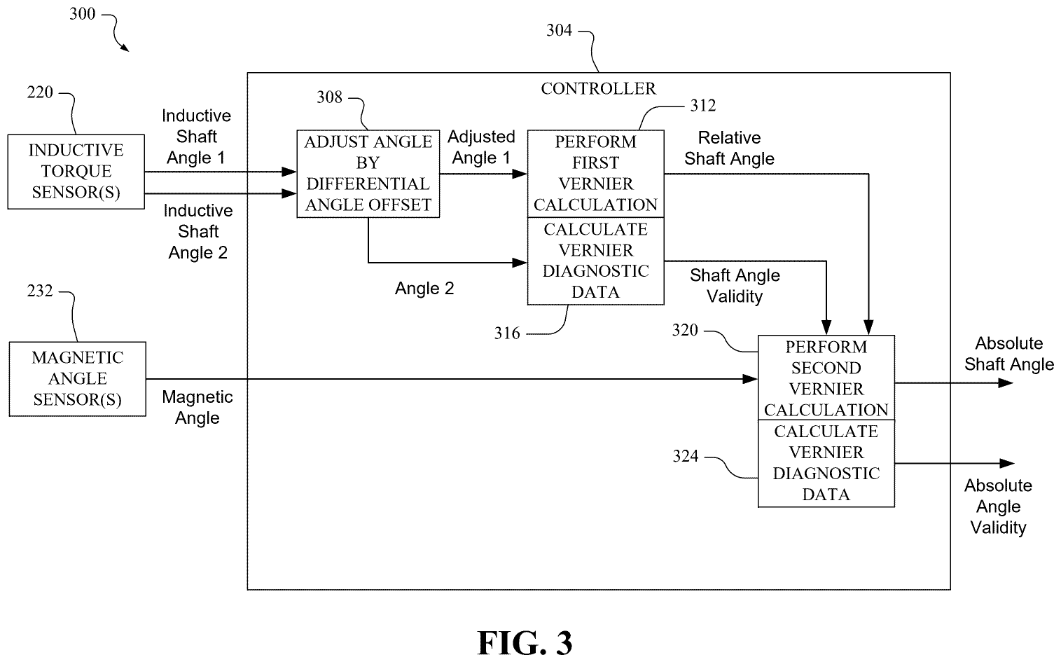

FIG. 3 shows an example system 300 and process for obtaining an absolute steering angle according to the present disclosure. The system 300 may include a controller 304 (e.g., a steering system controller) configured to perform various functions described herein to obtain the absolute steering angle. In an example, the inductive angle signals (e.g., shown as inductive shaft angles 1 and 2 in FIG. 3, as measured by respective inductive torque sensors 220) are first conditioned to remove the influence of a torsion bar twist angle that results from steering torque being applied to the input shaft. For example, the inductive angle signals are aligned through a calibration/trim procedure to ensure alignment between the inductive angle signals for execution of the steering angle algorithm. Alignment can be performed during manufacture and an installation of the inductive torque sensor 200. Since the inductive sensor 200 measures relative input and output shaft angles, the differential angle is directly calculable. As one example, as shown at 308, a differential angle (corresponding to a differential between the inductive angle signals) is calculated, to obtain a differential angle offset, and one of the inductive angle signals is adjusted by the differential angle offset. In other words, the calculated differential angle is applied to one of the inductive angle signals to remove the torsion bar twist angle, which aligns the inductive angle signals in a single rotational reference frame without torsion bar twist (as though both shafts are rotating simultaneously). In an example optimal implementation, the shaft angles are aligned based on the shaft that drives the gear wheel 224 (e.g., the output shaft 214) such that both inductive shaft angles are derived from the rotation of a same side of the shaft assembly comprising the shafts 212, 214.

Subsequent to aligning a selected one of the shaft angles (i.e., by applying the differential angle offset) to the other shaft angle, the inductive shaft angles are provided as inputs to a Vernier algorithm (e.g., a first Vernier algorithm or calculation performed by the controller 304, as shown at 312) to determine and output a relative shaft position or angle within 360 degrees of shaft rotation (e.g., a shaft angle from 0 to 360 degrees) or, in some examples, within a unit fraction of a rotation. In some examples, the controller 304 may be configured to perform diagnostics to track the inductive shaft angles and ensure no transient jumps in angle occur due to improper execution of the algorithm as shown at 316. As one example, the controller 304 monitors and compares the inductive shaft angles to determine whether a difference between the inductive shaft angles, a rate of change of the difference between the inductive shaft angles, etc. exceed threshold, which may indicate a transient jump or other error in results of the Vernier calculation. A shaft angle validity signal may correspond to a binary (e.g., 1 or 0) indicator of validity of the calculated relative shaft angle.

The relative shaft angle obtained using the first Vernier calculation and a magnetic gear angle (e.g., as obtained by the magnetic angle sensor(s) 232 as described above) are provided as inputs to a second Vernier algorithm (e.g., a second Vernier algorithm or calculation performed by the controller 304, as shown at 320). In an example, the magnetic gear angle as obtained by the sensor 232 may be calibrated for alignment to the steering shaft (one or both of the shafts 212, 214). The second Vernier algorithm is configured to (e.g., as executed by the controller 304) obtain an absolute shaft position or angle (corresponding to an absolute steering angle). The absolute shaft angle corresponds to multiple rotations of the steering shaft, dependent upon the gear ratio of the gear wheel 224 to the steering shaft (e.g., the shaft 212). In other words, rather than corresponding to an angle from 0 to 360 degrees, the absolute shaft angle is an angle from 0 to x degrees, where x varies based on the gear ratio. For example, x is greater than 360. Similar to the diagnostics performed at 316, the controller 304 may be configured to perform diagnostics to determine validity of results of the second Vernier algorithm as shown at 324.

In this manner, the second Vernier algorithm is configured to obtain a multi-turn absolute steering shaft angle and an absolute angle validity signal. Because the relative periodicity of the shaft angle and the gear wheel angle are closer to one another than either of the raw inductive angles (i.e., the signals obtained by the inductive torque sensors 220) and gear wheel angle (i.e., the signal obtained by the magnetic angle sensor 232), the second Vernier algorithm is more robust and tolerant to errors as compared to using the raw inductive angles. Accordingly, greater error is permitted for the gear wheel angle (e.g., due to assembly tolerances, temperature, lifetime drift, etc.) and the second Vernier algorithm can operate within a greater error margin to avoid algorithmic failures.

In an example, inductive angles θ₁ and θ₂ have different periodicities (e.g., p₁ and p₂, respectively) and a differential angle is represented by θ_{Δ}. Additionally, the inductive periodicities may be coprime, or they may have an integer greatest common divisor other than 1. In the case the 2 periodicities are coprime, the only common divisor is d=1, while if they have an integer common divisor other than 1, d takes the value of the greatest common denominator. As an example, an assumption can be made that each inductive angle measures an electrical period as an angle from 0 to 360. The inductive angles are normalized into a common gradient centered about 0 in accordance with

$${θ}_{1 norm} = ( {θ}_{1} - 180 ) \times \frac{{p}_{2}}{d} and {θ}_{2 norm} = ( θ - 180 ) \times \frac{{p}_{1}}{d} , and :$$

$${θ}_{Δ} = ( [ MOD ( {θ}_{1 norm} - {θ}_{2 norm} , 360 ) ] - 180 ) \times \frac{d}{{p}_{2}} .$$

The inductive angle θ₁, after being adjusted in accordance with the differential angle, corresponds to θ_{1Δ}=MOD(θ₁−θ_{Δ}, 360). Accordingly, θ_{1Δ} and θ₂ are provided as inputs to the first Vernier algorithm, which obtains the relative angle of the steering shaft within 360/d degrees of shaft rotation.

Conversely, the second Vernier algorithm obtains the absolute position or angle of the steering shaft over multiple turns using the relative angle of the steering shaft obtained by the first Vernier algorithm in combination with the magnetic gear wheel angle as described above.

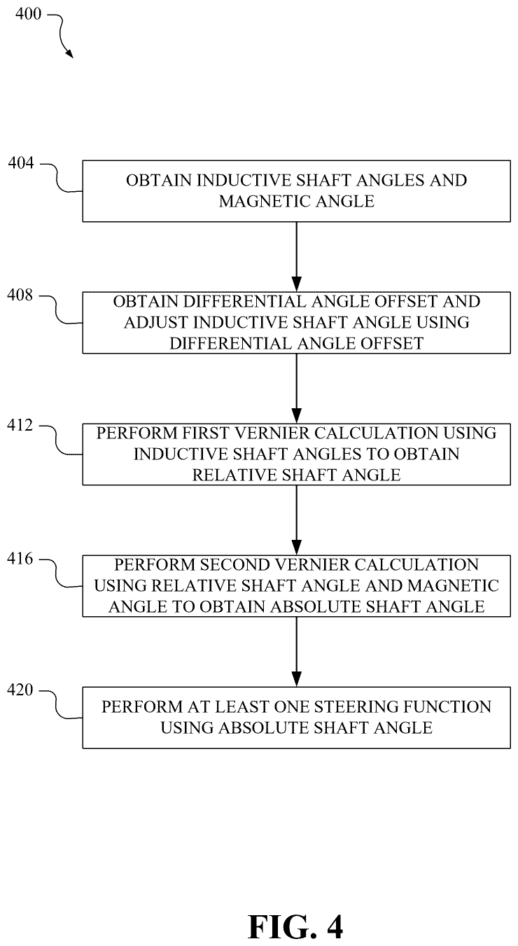

FIG. 4 is a flow diagram generally illustrating an absolute steering angle sensing method 400 according to the principles of the present disclosure. For example, one or more computing devices, processors or processing devices, etc. are configured to execute instructions to implement the method 400, such as one or more of the processors of the systems described herein (e.g., a computing device or processor of a vehicle configured to implement the system 300, the controller 304, etc.). One or more of the steps of the method 400 as described below may be skipped or omitted in some examples, and/or one or more of the steps may be performed in a different sequence than described.

At 404, the method 400 includes obtaining the inductive angles and the magnetic angle (e.g., using the inductive torque sensors 220 and magnetic angle sensor 232, respectively). At 408, the method 400 includes obtaining a differential angle offset and adjusting one of the inductive angles (e.g., inductive shaft angle 1, as shown in FIG. 3) using the differential angle offset.

At 412, the method 400 includes performing a first Vernier calculation using the inductive angles (e.g., the adjusted inductive shaft angle 1 and the inductive shaft angle 2). An output of the first Vernier calculation is a relative shaft angle (e.g., from 0 to 360 or another value in examples where a unit fraction of a rotation is used).

At 416, the method 400 includes performing a second Vernier calculation using the relative shaft angle obtained by the first Vernier calculation and the magnetic angle (e.g., corresponding to the magnetic gear angle) to obtain an absolute shaft angle (e.g., from 0 to x degrees, where x varies based on the gear ratio as described above).

At 420, the method 400 includes performing at least one steering function of a vehicle using the absolute shaft angle.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations of the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A system for controlling a steering system of a vehicle, the system comprising:
sensors configured to sense a plurality of values corresponding to operation of the steering system; and
a controller configured to
receive the sensed plurality of values, wherein the sensed plurality of values includes inductive angle signals and a magnetic angle signal,
based on the inductive angle signals, obtain a relative angle of a steering shaft using a first Vernier algorithm,
based on the relative angle obtained by the first Vernier algorithm and the magnetic angle signal, obtain an absolute angle of the steering shaft using a second Vernier algorithm, and
control the steering system based on the absolute angle obtained using the second Vernier algorithm.

2. The system of claim 1, wherein the sensors include a first inductive sensor configured to sense a first inductive angle, a second inductive sensor configured to sense a second inductive angle, and a magnetic sensor configured to sense a magnetic angle.

3. The system of claim 2, further comprising an inductive torque sensor that includes the sensors, wherein the inductive torque sensor is coupled to the steering shaft.

4. The system of claim 3, wherein the inductive torque sensor includes an input shaft, an output shaft, a torsion bar coupled between the input shaft and the output shaft, and a gear wheel coupled to the output shaft, and wherein the magnetic angle signal corresponds to a position of a magnet associated with the gear wheel.

5. The system of claim 4, wherein the controller is configured to calculate a differential angle offset between the input shaft and the output shaft and adjust the first inductive angle based on the differential angle offset.

6. The system of claim 5, wherein the controller is configured to obtain the absolute angle of the steering shaft further based on a gear ratio associated with the gear wheel.

7. The system of claim 6, wherein the relative angle is between 0 and 360 and the absolute angle is between 0 and x, where x is greater than 360.

8. A method for controlling a steering system of a vehicle, the method comprising:
sensing, using one or more sensors, a plurality of values corresponding to operation of the steering system;
receiving the sensed plurality of values, wherein the sensed plurality of values includes inductive angle signals and a magnetic angle signal;
based on the inductive angle signals, obtaining a relative angle of a steering shaft using a first Vernier algorithm;
based on the relative angle obtained by the first Vernier algorithm and the magnetic angle signal, obtaining an absolute angle of the steering shaft using a second Vernier algorithm; and
controlling the steering system based on the absolute angle obtained using the second Vernier algorithm.

9. The method of claim 8, wherein the one or more sensors include a first inductive sensor configured to sense a first inductive angle, a second inductive sensor configured to sense a second inductive angle, and a magnetic sensor configured to sense a magnetic angle.

10. The method of claim 9, wherein the one or more sensors are components of an inductive torque sensor, wherein the inductive torque sensor is coupled to the steering shaft.

11. The method of claim 10, wherein the inductive torque sensor includes an input shaft, an output shaft, a torsion bar coupled between the input shaft and the output shaft, and a gear wheel coupled to the output shaft, and wherein the magnetic angle signal corresponds to a position of a magnet associated with the gear wheel.

12. The method of claim 11, further comprising calculating a differential angle offset between the input shaft and the output shaft and adjusting the first inductive angle based on the differential angle offset.

13. The method of claim 12, further comprising obtaining the absolute angle of the steering shaft further based on a gear ratio associated with the gear wheel.

14. The method of claim 13, wherein the relative angle is between 0 and 360 and the absolute angle is between 0 and x, where x is greater than 360.

15. A processor configured to execute instructions stored in memory, wherein executing the instructions causes the processor to control a steering system of a vehicle, the instructions comprising:
sensing, using one or more sensors, a plurality of values corresponding to operation of the steering system;
receiving the sensed plurality of values, wherein the sensed plurality of values includes inductive angle signals and a magnetic angle signal;
based on the inductive angle signals, obtaining a relative angle of a steering shaft using a first Vernier algorithm;
based on the relative angle obtained by the first Vernier algorithm and the magnetic angle signal, obtaining an absolute angle of the steering shaft using a second Vernier algorithm; and
controlling the steering system based on the absolute angle obtained using the second Vernier algorithm.

16. The processor of claim 15, wherein the one or more sensors include a first inductive sensor configured to sense a first inductive angle, a second inductive sensor configured to sense a second inductive angle, and a magnetic sensor configured to sense a magnetic angle.

17. The processor of claim 16, wherein the one or more sensors are components of an inductive torque sensor, wherein the inductive torque sensor is coupled to the steering shaft.

18. The processor of claim 17, wherein the inductive torque sensor includes an input shaft, an output shaft, a torsion bar coupled between the input shaft and the output shaft, and a gear wheel coupled to the output shaft, and wherein the magnetic angle signal corresponds to a position of a magnet associated with the gear wheel.

19. The processor of claim 18, the instructions further comprising calculating a differential angle offset between the input shaft and the output shaft and adjusting the first inductive angle based on the differential angle offset.

20. The processor of claim 19, the instructions further comprising obtaining the absolute angle of the steering shaft further based on a gear ratio associated with the gear wheel.
